(19) United States
(12) Patent Application Publication
(10) Pub. No.: US 2009/0209275 A1
(43) Pub. Date: Aug. 20, 2009

(54) MESSAGE ROBOT

(76) Inventor: Ian M. Moraes, Suwanee, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/335,967

(22) Filed: Dec. 16, 2008

Related U.S. Application Data
(60) Provisional application No. 61/028,596, filed on Feb. 14, 2008.

(51) Int. Cl. H04W 4/12

(52) U.S. Cl. 455/466

(57) ABSTRACT

Enhanced messaging provided by allowing a subscriber to send a message to the system, and in response to the message, providing an enhanced messaging service. The enhanced messaging service may include receiving and forwarding content to intended recipients, providing previously received content to a requesting party, or obtaining content commensurate to a request from the subscriber and delivering that content to the subscriber.

### CROSS-REFERENCE TO RELATED APPLICATIONS

This application claims the benefit and priority of U.S. Provisional Application for Patent that was filed on Feb. 14, 2008 and assigned Ser. No. 61/028,596, such application is hereby incorporated by reference. This application is related to the U.S. application for patent that was filed on Feb. 10, 2006 and assigned Ser. No. 11/352,443 and the one that was filed on May 17, 2007 and assigned Ser. No. 11/749,785, and the one that was filed on Mar. 15, 2005 and assigned Ser. No. 11/080,744, all of which are incorporated herein by reference.

### BACKGROUND

It would be difficult to actually pin point who was responsible for the actual conception of the term robots but, some have attributed the conception to the Czech playwright Karel Capek who wrote a play in 1920 about humanoid machines that turn against their creators. Capek called these imaginary creations “robots” which originated from the Czech word for “slave labor”.

Regardless of the origination of the term, it is quite apparent that many are concerned about the potential of our world be over taken or over run by robots. This concern has led to the development of the three laws of robotics:
(a) A robot may not hurt a person or allow a person to be hurt;
(b) Robots must follow all orders given by humans unless they conflict with the first law; and
(c) A robot must protect itself as long as it does not conflict with the first two laws.

Authors, playwrights, producers and Hollywood have been capitalizing on this concept for many years now. The beast has reared its head again recently in the movie I, ROBOT staring Will Smith. But maybe the world is too busy looking for a large scale invasion, so busy that they miss the “in the back door” sneak attack. In deed, robots are all around us and they are taking over the world—so to speak. In many aspects, our quality of life is greatly improved because of these robots. However, many robots are taking quite different forms that what is traditionally expected. Rather than humanoid forms walking around with mechanical faces, robots are most prevalent right inside your own computer, interacting with you on the Internet, routing your mail, tracking weather, controlling traffic lights, etc. In general, a robot can be viewed as anything that can be programmed to perform or assist in the performance of a task. As such, your personal computer is probably loaded to the hilt with robots.

One of the arenas of life that seems to be consuming more and more of one's time is messaging services. The amount of time an individual spends reading, composing and responding to the various types of messaging is greatly increasing. In fact, some may even classify it as epidemic—especially when you start lumping in all the spam and solicitations that are received via email. How can robots help us out in this arena? Are we talking about a robot, sitting at our computer and responding to emails while holding our cellular telephones and responding to text messages. In a way, yes. What is needed in the art is a solution to automate or at least provide some level of automation to the process of receiving, handling and responding to messaging systems.

### SUMMARY

Various embodiments of the present invention are directed towards an enhanced messaging service. One aspect of the invention is providing a message robot that receives messages, parses the messages to identify actions to be invoked from the messages, and then takes such action.

More specifically, on embodiment of the invention provides an enhanced messaging service by defining, or receiving definitions for one or more trigger events. In operation, a message is received and then parsed to determine if one or more of the trigger events are satisfied. If a trigger event is detected, then an action is taken which includes the delivery of content to a destination. The received message can take on a variety of forms. For instance, the received message may be in the form of an SMS message that includes or identifies the content to be delivered. In this embodiment, in response to receiving the message, the invoked action may including delivering the content by first identifying the sender of the SMS message, verifying that the sender is approved to receive the identified content and then sending the content to the sender.

The content can be sent to the sender in a variety of manners. For instance, the content can be sent in the form of an SMS, text message, MMS, video mail, audio call, etc.

In a particular embodiment, the received message may include content to be delivered and then delivering the received content to the destination. Further, in some embodiments the trigger event may include information to identify one or more destinations. In such an embodiment, invoking an action may include delivering the content to the one or more destination. For instance, if the content is a pre-recorded audio message, the content can be delivered by calling destination numbers and playing the pre-recorded audio message. Further, the received message may bean SMS message and the prerecorded content can be sent to a destination by out-dialing a number identified in the SMS message and playing the prerecorded content.

In another embodiment, the received message can be an SMS message that includes information to identify the content. In such an embodiment, the sender of the SMS can be identified and a process can be invoked to verify that the sender is approved to receive the identified content. If the sender is approved, the content can be sent to the identified sender.

Another aspect of embodiments of the invention involves the reception of a voice message. This aspect of the invention involves parsing the voice message to detect specific words within the voice message that may satisfy the trigger requirements.

In yet another embodiment of the invention, the received message includes information to identify a product and a location. In this embodiment, the step of invoking an action for the delivery of content further comprises obtaining content related to the product and availability information related to the product and the location. The identity of the sender is then identified and the obtained content is sent to the sender.

Another embodiment of the present invention may includes a content storage device and a media server. In this embodiment of the invention, the media server includes an interface to the storage device and a network. The media server includes an application that can receive a message from the network, parse the message for a trigger event and upon detecting a trigger event, extract content from the content storage device and send the content to a destination over the network.

Thus, the various embodiments, aspects and features of the invention provide an enhanced messaging service. The enhanced messaging service can be used to provide the delivery of content to particular destinations or, used to obtain information by a subscriber or user. A subscriber can upload information or content to be delivered to destinations and simultaneously or subsequently, invoke the delivery of the content to the various destinations. In addition, users can send messages to the system to be processed and invoke the delivery of content. The sent messages may contain content that once identified, triggers the delivery of content. Advantageously, the various embodiments of the invention can operate as a messaging assistant by interpreting received messages and taking appropriate action based on the content of the messages. In various embodiments, the system operates as a message robot that identifies triggers either defined by a subscriber, pulled from stored definitions, generated by the robot, or a combination of two or more of these techniques, and then takes actions based on the identified triggers.

### BRIEF DESCRIPTION OF THE DRAWINGS

FIG. 1 is a system diagram illustrating the components and the connectivity of an exemplary platform in which aspects and embodiments of the present invention could be incorporated.

FIG. 2 is a system diagram illustrating the components and the connectivity of an exemplary platform supporting various aspects of the present invention.

FIG. 3 is a flow diagram illustrating the steps involved in an exemplary embodiment of the invention in which a robot performs the preparation and delivery of messages.

FIG. 4 is a flow diagram illustrating the steps involved in an embodiment of the present invention including the in-processing aspects.

### DETAILED DESCRIPTION

The various embodiments, aspects and features of the present invention, in general, are directed towards a tool that automates activities related to processing of various messaging services. One aspect of the invention facilitates the in processing of received messages. Other aspect of the present invention facilitates the preparation and delivery of messages. For the in processing aspects of the present invention, one action can include listening to messages in a user's in box, interpreting the messages and then taking actions. For instance, one embodiment of this aspect may read an email message and upon recognizing certain words or phrases, take a specific action. In another embodiment, speech recognition may be performed on a voice message to identify key words or phrases that trigger an action.

For the preparation and delivery aspects, one embodiment of the invention may allow a requester to send a simple text message or other message type towards a user. This embodiment of the invention can preview the message and then retrieve and send a pre-recorded message to the requester. All of this can be performed automatically without the intended recipient even having to respond to the message.

Turning now to the figures, various aspects, features and embodiments of the present invention will be described in further detail.

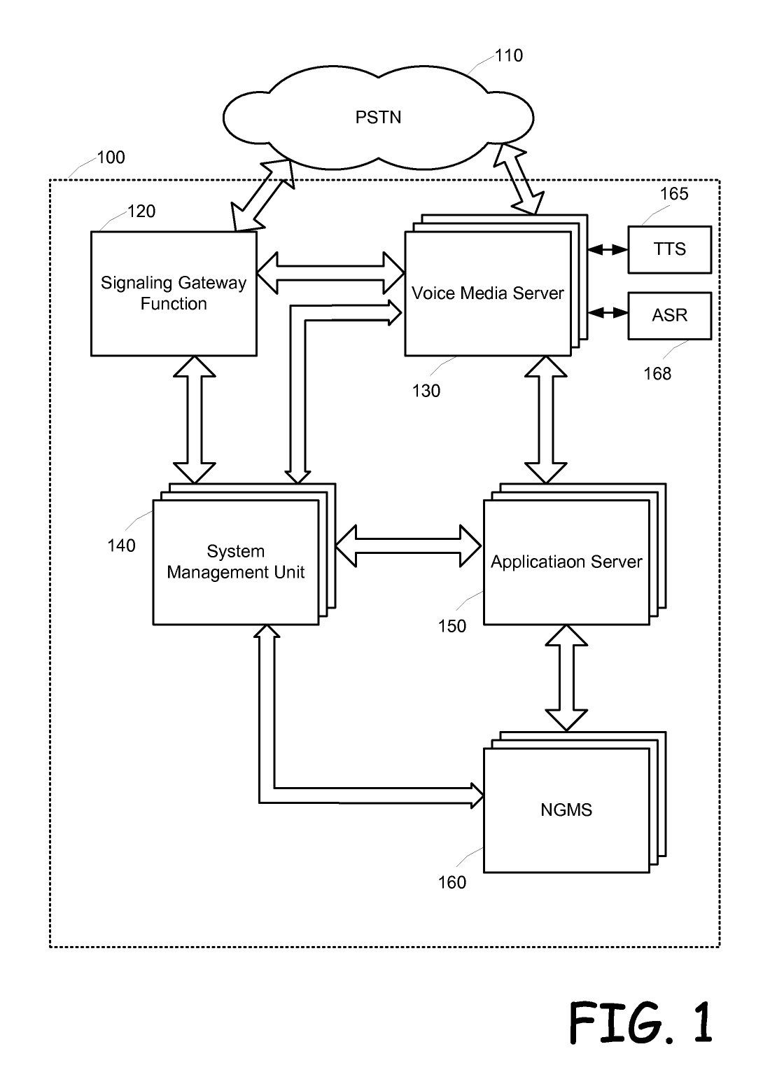

FIG. 1 is a system diagram illustrating the components and the connectivity of an exemplary platform in which aspects and embodiments of the present invention could be incorporated. In the illustrated embodiment, the platform 100 employs a distributed IP architecture and is connected to the Public Switched Telephone Network (PSTN) 110. The communications platform 100 is illustrated as including a signaling gateway function (SGF) 120, one or more media servers (MS) 130, one or more system management units (SMU) 140, one or more application servers (AS) 150 and one or more next generation message stores (NGMS) 160.

In general, the SGF 120 serves as the Signaling System 7 (SS7) interface to the PSTN 110. The media server 130 terminates IP and/or circuit switched traffic from the PSTN via a multi-interface design and is responsible for trunking and call control. The application server module 150 generates dynamic VoiceXML pages for various applications and renders the pages through the voice media server 130 and provides an external interface via a web application server configuration. The SMU 140 is a management portal that enables service providers to provision and maintain subscriber accounts and manage network elements from a centralized web interface. The NGMS 160 stores voice messages, subscriber records, and manages specific application functions including notification.

The voice media server 130 terminates IP and circuit-switched voice traffic and is responsible for call set up and control within the system. The voice media server 130 processes input from the user in either voice or DTMF format (much like a web client gathers keyboard and mouse click input from a user). It then presents the content back to the user in voice form (similar in principle to graphic and text display back to the user on a PC client). This client server methodology enables rapid creation of new applications and quick utilization of content available on the World Wide Web.

The voice media server 130 processes incoming calls via requests to the application server 150 using HTTP. A load balancer directs traffic arriving at the voice media server 130 to one of a plurality of applications servers 150. This functionality ensures that traffic is allocated evenly between servers, and to active servers only. The voice media server 130 works as the VoiceXML client on behalf of the end user in much the same manner as a client like Netscape works on behalf of an HTML user on a PC. A VoiceXML browser residing on the voice media server 130 interprets the VoiceXML documents for presentation to users.

The voice media server 130 interfaces with the PSTN, automatic speech recognition server (ASR) 168 and text-to-speech server 165 (TTS) and provides VoIP (SIP, H.323) support. Incoming circuit switched voice data in 64-kilobit micro-law or A-law pulse code modulation (PCM) format is compressed using G.726 for voice storage in the NGMS 160. VoIP is supported through G.711 and G.723 voice encoding. The voice media server 130 contains a built-in abstraction layer for interface with multiple speech vendors—eliminating dependency on a single ASR 168 or TTS 165 vendor.

The voice media server 130 can include built in codecs and echo cancellation. Call detail records (CDRs), used by service providers for billing purposes, are provided as well as SNMP alarming, logging, and transaction detail records.

Each of these sub-systems is described in more detail in the U.S. patent application Ser. No. 11/080,744 which is incorporated by reference.

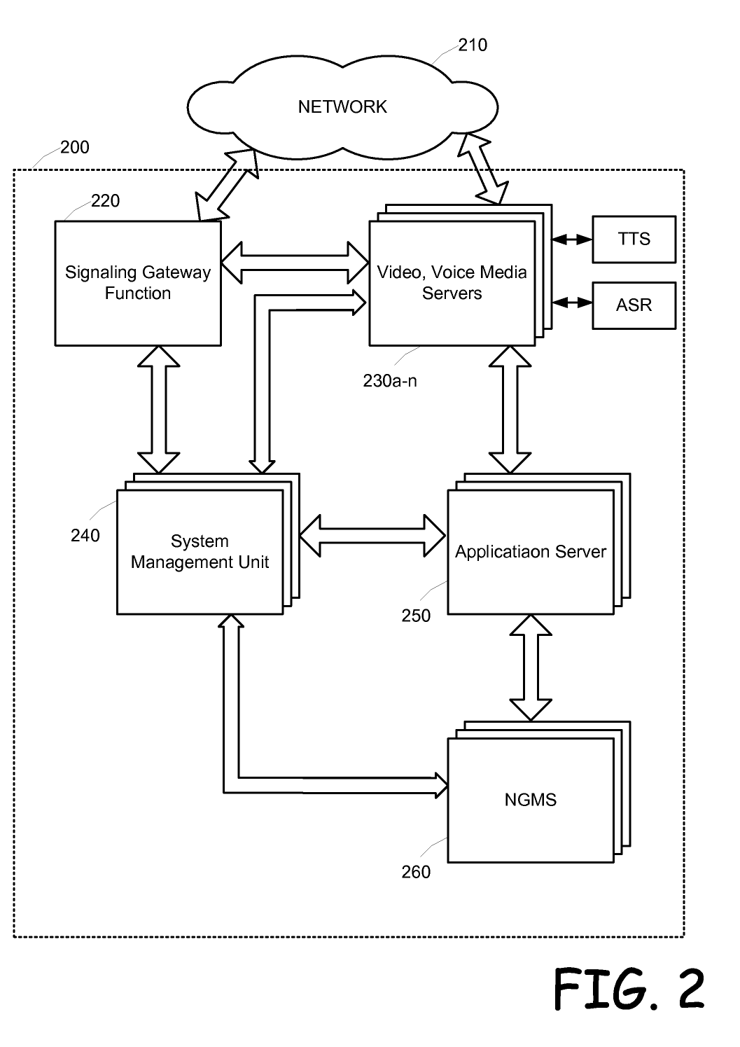

FIG. 2 is a system diagram illustrating the components and the connectivity of an exemplary platform supporting various aspects of the present invention. In the illustrated embodiment, the platform 200 employs a distributed IP architecture and is connected to a network 210. The communications platform 200 is illustrated as including a signaling gateway function (SGF) 220, one or more media servers (MS) 230a-n, one or more system management units (SMU) 240, one or more application servers (AS) 250 and one or more next generation message stores (NGMS) 260.

In general, the SGF 220 serves as the Signaling System 7 (SS7) interface to the network 210. The media servers 230 terminate IP and/or circuit switched traffic from the network via a multi-interface design and is responsible for trunking and call control. In addition, the media servers 230 render interface information to an end user device. For instance, during a voice telephone call a media server may render VoiceXML content. During a video call a media server may render media content of various types, with our without VoiceXML content.

The application server module 250 generates dynamic VoiceXML pages, recalls VoiceXML pages from memory and recalls various media content from memory for various applications and renders the pages through the media servers 230a-n. Furthermore, the application server module 250 may provide an external interface via a web application server configuration. Through this interface, a user may access the various features or functions for creating video media applications. For instance, the user may define the navigational menus, animation associated with various menu items, etc. The SMU 240 is a management portal that enables service providers to provision and maintain subscriber accounts and manage network elements from a centralized web interface. The NGMS 260 stores voice messages, subscriber records, and manages specific application functions including notification.

The voice media server 230 terminates IP and circuit-switched voice traffic and is responsible for call set up and control within the system. The voice media server 230 renders the user defined video media applications and processes input from the user in either voice or DTMF format (much like a web client gathers keyboard and mouse click input from a user). It then presents the content back to the user in voice and/or video form (similar in principle to graphic and text display back to the user on a PC client). This client server methodology enables rapid creation of new applications and quick utilization of content available on the World Wide Web.

The media server 230 may process incoming calls via requests to the application server 250 using HTTP. A load balancer can be used to direct traffic arriving at the voice media server 130 to one of a plurality of applications servers 250. This functionality ensures that traffic is allocated evenly between servers, and to active servers only. The media server 130 works as the VoiceXML and media client on behalf of the end user in much the same manner as a client like Netscape works on behalf of an HTML user on a PC. A browser residing on the voice media server 130 interprets the VoiceXML and media documents for presentation to users.

Thus, the platform as structured in FIG. 2 can support voice, video and data applications. The video applications include both application logic, such as VoiceXML code, as well as media, such as video menus, video services, etc. When a subscriber places a call, such as a 3G video call, that is received by the platform, the media server 230 answers the call and starts a VoiceXML browser. Further, the media server 230 requests VoiceXML application pages from the application server 250. The application logic is executed and the associated media is presented. As subscriber actions are received, the actions result in further application logic being executed and new media being presented or the call is ended.

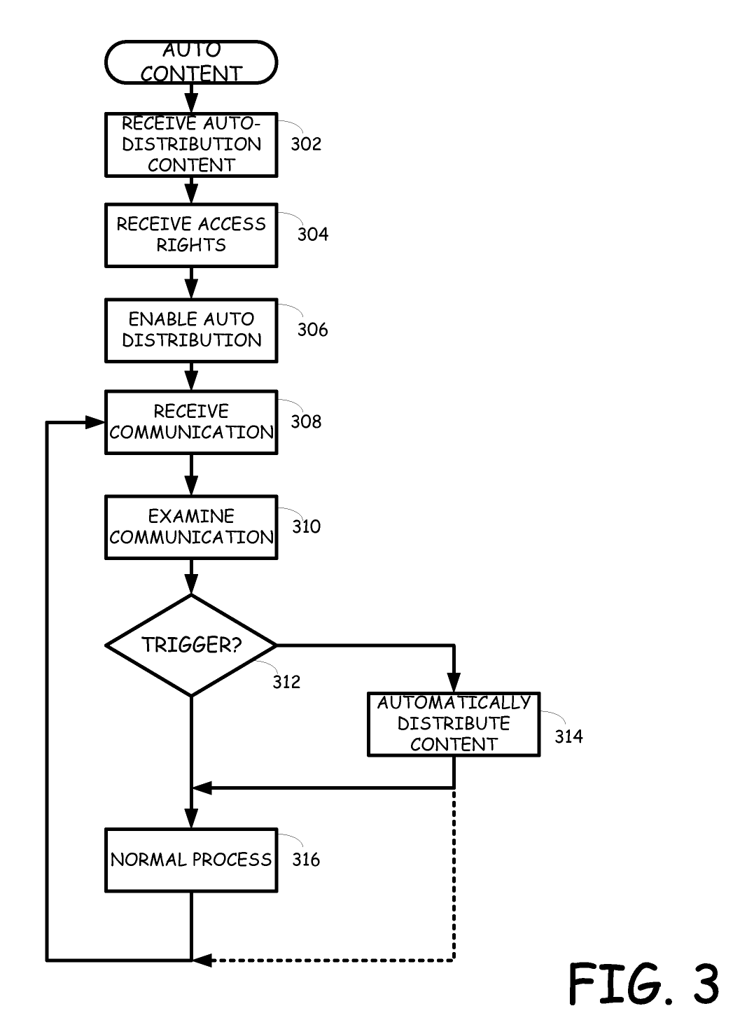

FIG. 3 is a flow diagram illustrating the steps involved in an exemplary embodiment of the invention in which a robot performs the preparation and delivery of messages. The steps in the flow diagram are viewed from the perspective of a system that can perform these functions and provides the inventive operation. In some embodiments a user must interact with the system to provide the necessary information while in other embodiments, the system may simply access a pre-prepared database or information may be generated on the fly.

Initially the system receives content that is to be automatically distributed 302. The content can be obtained in a variety of manners. For instance, as a few non-limiting examples, the system may request a user to provide content, a user may create and provide the content, a user may simply identify content already obtained by the system, and/or the user may identify other content that can be accessed by the system.

Once the content is obtained and/or identified, the system receives access rights for that content 304. The access rights can comprise a variety of settings and parameters and can be provided to the system in a variety of manners. The access rights may include one or more parameters that identify parties that can access the content. For instance, a few non-limiting examples of identifying parameters include email addresses, telephone numbers, email domains, area codes, user identities, passwords, access codes, or the like. Further, some embodiments may require special words, identities, or other triggering items to be embedded in a request for the content. The access rights may also include a time of day, a day of the week, an expiration time, or other such time oriented limiting factors.

The access rights may also be classified in levels. For instance, a user that falls into one group may obtain full access rights while other groups may have varying limited rights. Access rights may also be based on monetary remuneration. For instance, prior to providing access a credit card number may be required, a charge cleared against a credit must be performed, available funds must be identified and/or obtained, or other techniques. The access rights may also be based on age, gender, nationality, or any of a variety of other factors.

The access rights can be defined by a user interacting with the system, defined by a lookup database, defined by a combination of both of these techniques as well as employing other techniques. For instance, in one exemplary embodiment a user may be required to enter the email address and telephone number of each party that the user wants to provide access to the content. In addition, the user can define access rights parameters for a piece of content and subsequently provide information pertaining to one or more parties that can potentially access the content. For instance, a user may provide the following access parameters for a content item:

Minimum age of 18

Valid drivers license for particular State X

Active member of chamber of commerce

Based on these criteria, the user may enable the domain of the world to access the content if they meet this criteria. Alternatively, the user may require further identifications. For instance, subsequently to entering the above-parameters, the user may enter information regarding particular individuals. If the information regarding the individuals satisfies the provided access parameters, the individual may gain access to the content, otherwise access would be refused.

Alternatively, the system may also employ the use of a database in obtaining access rights. For instance, a user may enter a variety of parameters, such as those listed above. The system can then identify individuals in a database that satisfy the entered criteria. Thus, a variety of techniques can be used to define the access rights for content including: (a) identifying users that can access the content; (b) identifying characteristics or parameters of individuals that can access the content; (c) identifying users and necessary characteristics; as well as other techniques such as requiring a user id and/or password, etc. In addition, no access rights may be identified and thus, providing total public access to the content.

Subsequent to or prior to receiving access rights, the auto distribution of the content can be enabled 306. Enabling the auto distribution operates as a switch which once thrown into the on position, will provide the content to requesters or pulls (or in some embodiments may even push the content) if the access rights are satisfied.

It will be appreciated that although the steps 302, 304 and 306 are presented in a linear fashion, it is not necessary for these steps to be performed linearly. In addition, portions of the steps can be completed at various times, and steps can be repeated to modify, augment, delete or otherwise change content, define access rights and enable or disable the auto distribution.

In parallel with the previously mentioned steps, the system may constantly be available to receive communications from various sources 308. Communications may arrive in a variety of formats, including as non-limiting examples, emails, voice calls, video calls, text messages, pages, etc.

Once a communication is received, the system examines the communication 310. The communication is examined to determine if sufficient criteria is met to trigger the automatic delivery or access to the content, or in some embodiments, simply meets the criteria for taking an action. For instance, in one embodiment, an email message may be received at step 308 and the examination step 310 may include identifying addresses of the sending party. If the sending party is on an access list, one or more content items available for that individual can be automatically emailed to the individual. As another example, the email address of the party can be identified and then the subject line of the email can be parsed for content identifiers. In response to determining that the email address has access to content, the content associated with keywords included in the subject line can be accessed and delivered to the requester.

As another example, embodiments of the invention may be operable to receive a voice mail message. Content can then be delivered to a qualified requester using a variety of techniques including, but not limited to, email, voicemail, pre-recorded voice message, text message, video message, etc. The requester can be qualified based on the CLID of the requester or other criteria. For instance, if the requester leaves a voice message, the content of the voice message can be processed by a speech recognition engine to identify qualifying access parameters, such as user name, passwords, content identifiers, key words, etc. Furthermore, an intelligent processor could parse an unformatted, raw message to decipher what the caller is looking for and either take determined action, present a conclusion to the caller for confirmation or present a list of possible conclusions from which a user can select the match, closest match, request the processor to make another try and/or provide additional information to the processor to assist in such determination.

As yet another example, a requester may send a text message identifying particular content and providing a user identifier and password for accessing the content. In response the system may parse the text message and verify the requester is authorized to receive the identified content.

If the system determines that a received communication includes one or more qualifying triggers 312, then content associated with the qualifying triggers may be automatically distributed to the requester 314. The content can be distributed in accordance with a default technique, selecting any one or more of the various available techniques including email, voicemail, text, regular mail, overnight mail, paging, video calls, etc, or may be delivered using a technique identified by the requester in the communication or subsequently identified by the requester.

If the communication does not result in a trigger, then the communication can be disposed of in the normal operation of the communication system 316. For instance, an email message may be delivered to the destination in-box, a voice mail message may be recorded, a call may be routed to the user, etc.

It will also be appreciated that after the automatic distribution of the content, the message may also be processed in accordance with normal processing 316 or the communication can be discarded or otherwise processed.

Processing can continue by returning to step 308 to receive further communications understanding that at anytime, the user may also cause a return to steps 302, 304 and/or 306 to modify the content, define new content, modify the access rights, and enable or disable auto distribution.

A further understanding of this inventive aspect can be obtained through the provision of a few non-limiting examples. In one example, an embodiment of the present invention may be used to provide information to various individuals. For instance, if a user finds an item, such as a lost dog, the user can post a sign requesting parties to call a certain number or send an email to a certain address. The user can then define content that describes the item (i.e., young golden retriever, red collar, no tags, light nose, dark brown mark on left ear), the location that the item was found (i.e, 3 North Main Street, Duluth Ga. on Wednesday April 2nd), and how to claim the item or obtain further information (i.e., call Mr. Lucky between the hours of 5:00 pm and 8:00 pm at 770-555-4343). Any parties that call the number and/or send an email message to the email address can result in a trigger of automatic distribution of the content.

This embodiment of the invention may be equally applicable to provide information pertaining to a vehicle for sale, real-estate for sale, etc. In addition, in the real-estate example, the content may include content for multiple listings such as would be used by a real estate agent. The message provided by a requester may include an MLS listing number or other insignia to identify which property is the subject of the inquiry. Further the message may provide the identify of the requester and, if the requester is presently associated with a particular agent, information content about that agent may be provided to the requester. If the requester is not associated with an agent, the requester may be denied access or rather be provided with contact information for an available agent.

As another example, embodiments of the present invention may be utilized to provide a directory of information to the public or certain classes of requesters. For instance, the county extension may provide various items of content to requesters using an embodiment of the present invention. The items can be provided to the public at large or, the identity of the requester can be provided and a database lookup may provide access only to requesters that are current residents of the county. In one embodiment, the items provided can be based on their existence in a certain directory or file structure. For instance, a defined class of requesters may have access to all the files in a particular directory. Simply by placing a content item into that directory provides access to the content for each requester in the defined class.

As another example, a university professor may provide homework assignments, class notes or other information to requesters that provide their student id number. A database lookup can verify that the student is enrolled in the class before distributing the content to the requester. Such an embodiment can be beneficial in controlling the distribution of copyrighted material, as well as tracking the distribution for royalty payment purposes. As another example, the status of a hospitalized patient may be provided to select individuals or family members.

For the in-processing aspects of the present invention, one action can include listening to messages in a user's in box, interpreting the messages and then taking actions. For instance, one embodiment of this aspect may read an email message and upon recognizing certain words or phrases, take a specific action. In another embodiment, speech recognition may be performed on a voice message to identify key words or phrases that trigger an action. Various embodiments of this inventive aspect can be used to perform various functions. For instance, as previously described, embodiments may result in the delivery of pre-recorded messages or content to a requester. Other embodiments may result in other actions, such as ordering a desired item, ordering the filling of a prescription, requesting an automatic bill payment to a vendor, setting a reminder message or scheduling a meeting, setting up a conference call reservation, adjusting environmental controls in a home or office, etc.

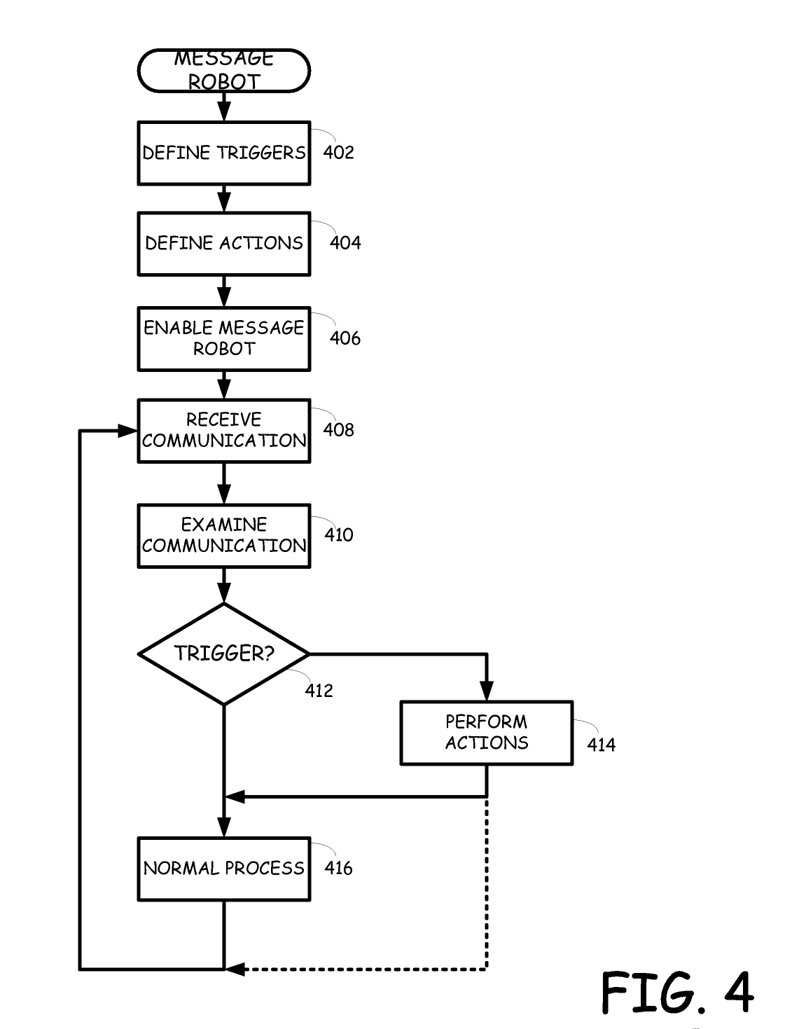

FIG. 4 is a flow diagram illustrating the steps involved in an embodiment of the present invention including the in-processing aspects. This flow chart illustrates the operation of one embodiment of a message robot that can receive and autonomously or semi-autonomously respond to the message. Initially, the message robot or a user defines triggers 402. The triggers can be defined by a user, pulled from a default list of triggers, a combination of both, as well as the application of artificial intelligence and other parameters including dates, time, weather, news events, etc. In addition, the message robot defines actions to be performed 404. Again, the actions can be defined by a user, pulled from a default list of triggers, a combination of both, as well as the application of artificial intelligence and other parameters. Once the triggers and actions have been defined, or even during this process, the message robot is enabled for the processing of incoming messages 406. A message is received or intercepted by the message robot 408.

The message robot can be enabled to receive and respond to messages in a variety of fashions. For instance, in one embodiment, the message robot may be an integral part of a company's email server and voice mail system and enabled to process all incoming messages. In another embodiment, the message robot may be integrated into a telecommunications system and operate to process messages passing through the system at a variety of levels, such as main switches, service nodes, etc. In another embodiment, the message robot may be integrated into a plurality of nodes in an IP network. Such an embodiment may be utilized to capture and filter out SPAM or illicit content, as well as to determine optimum routes for traffic and routing packages. In another embodiment, the message robot may reside on an individual's personal computer running as a background process or as an extension to an email server or application, such as OUTLOOK, OUTLOOK EXPRESS, etc. In yet another embodiment, the message robot may reside on an individual's PDA or cellular telephone. In addition, embodiments of the invention may be distributed among multiple platforms and operate either independently or in conjunction with each other. For instance, a distributed embodiment may reside on an individual's personal computer, mobile device and the email server of his or her employer. In such an embodiment, the message robot can receive a message on the mobile device and based on a rule, notify the message robot residing on the personal computer to take a particular action.

Looking specifically at the embodiment illustrated in FIG. 4, when a message or communication is received, the message robot operates to examine the communication 410. If the message robot identifies a trigger, or if the message or communication invokes or includes one or more triggers 412, then the message robot performs an appropriate action 414. After performance of the action, the communication or message may be discarded, saved or, normal processing for the message can be invoked 416. If the communication or message does not include a trigger, the normal processing of the message is performed 416. In either case, the message robot then returns to step 408 to await the next communication or message.

It should be appreciated that the steps of defining triggers 402, defining actions 404, and enabling or disabling the message robot 406 do not have to be one time, linearly performed events. Rather, the operations associated with each of these steps, in some embodiments, can be invoked at any time. Thus, a user or administrator can add new triggers and actions while the message robot is operating and the message robot can use artificial intelligence, heuristics, or other information to dynamically create or delete triggers.

It should also be appreciated that the message robot may be implemented as a multi-tasking or multi-threaded application and able to process multiple messages and support multiple users simultaneously.

It should also be appreciated the present invention may be adapted to work with and processes outgoing communications and/or messages. For instance, based on the defined triggers and actions, if the message robot is enabled, messages transmitted by a user via email, SMS, text messages, webpage or website configuration or interaction, or even over an audio or video line can be intercepted or monitored by the message robot. As a specific example, a message robot residing on a company's email server may examine outgoing email messages and, if it determines that the outgoing message contains company confidential information, the message robot may prevent the transmission of the message, provide a notice to the sender, route the message to the company's confidential information custodian, or the like depending on the actions or rules definition. In another embodiment, the message robot may monitor a voice call and certain words can be triggers for actions. For instance, if a party states “send me a copy of the annual report” the message robot may identify the trigger and then operate to retrieve the annual report, look up the destination email or physical address of the party (such as based on the called number or the CLID) and then forward the annual report. Other non-limiting examples may include trigger words to invoke the message robot to record the conversation, take minutes on the telephone call, detect and record contact information then update contact information databases, detect client/matter numbers and track and report time associated with the telephone call, etc.

It will be appreciated that the present invention, and various aspects and embodiments thereof, may be used in a variety of contexts to perform a variety of functions. One such non-limiting example is in the provision of a marketing blitz. This embodiment would provide a tool for marketing campaigns, real estate sales of for users who want to show off their talents, skills or activities (for instance to automatically post onto a user's blog). In operation, the user could record a video message and then deposit it into a mailbox. The mailbox can then push the message to a recipient list. Typically, similar applications are limited to sending to a single recipient. However, this embodiment would enable a single video to be sent out automatically to multiple recipients. More specifically, a user may record video content to be distributed and then email the video content to his or her address, or to an address that would invoke the message robot. The message robot can automatically, or based on the content or keywords embedded in the message or header of the email, be triggered to take actions. The actions may include sending the content to an identified list of recipients, a class of recipients or taking other actions, such as but not limited to posting the content to the sender's blog.

In another embodiment, the present invention may be used as a shopping assistant. In many situations, a consumer may find themselves shopping for an item in which they are faced with a large number of choices, options or configurations. For instance, this can occur when shopping for a computer, consumer electronics, etc. Using an embodiment of the present invention, a user can send a message to a server housing the robot, such as a text message, email, voice message, etc, and provide identifying information to the server. As an example, the user may provide the UPC code of the product, a model number, etc. In response, the server can retrieve, synthesize and deliver information to the consumer such as the price of the product at different stores, the price of the product based on the inclusion/exclusion of various features, accessories, configurations, on-line prices (i.e., it may return a ling to GOOGLE's FROOGLE service, comparable products and prices, etc. The information may be delivered to the server in a variety of manners. For instance, the user may point a video camera and video record, or using a camera equipped mobile telephone take a picture of, the barcode or UPC label or model/serial number. Alternatively, the user may enter this information into an SMS, text message, email or voice recording.

Thus, in an embodiment of a shopping assistant, it is appreciated that the message robot can provide a variety of services. These services may also be linked to location based information. For instance, the message sent to the server may include the consumers ZIPCODE, address or GPS coordinates. Thus, if a consumer is using a GPS equipped mobile telephone, the current location can also be sent to the server. The server can then provide pricing, comparison and availability of the product at nearby stores. In addition, it will be appreciated that this embodiment may also provide reviews regarding the product, recall notices, product ratings, CONSUMER REPORTS or similar information pertaining to the product. Furthermore, the server may maintain a list of favorite shopping locations of the consumer and filter the information based on this list.

Some embodiments of this invention, as previously described, can be client based in that the service, or portions of the service can be provided through an application running on the consumer's client product, such as a mobile telephone or PDA. Other embodiments may also be clientless in that the service can be provided entirely by the server through a video call, voice call, etc.

Another exemplary use of the present invention is a navigational oriented application.

In this scenario, a user can send a text message or SMS to the server requesting directions and receive instructions via a text message or SMS. For instance, the user can press a single key on his or her mobile telephone and receive directions to his or her home from their current location. Alternatively, the user can define a destination location and then receive directions to that location. The directions can be in the form of SMS messages delivered in bulk to the user's mobile device or, may be provide on an as needed basis. In such an embodiment, the directions may dynamically change based on traffic, weather, or other circumstances or information. For example, the mobile device can continuously provide current location information to the server. Based on this information, the server can modify or maintain the directions provided to the user. As an example, if the server detects that a user is moving slower on a particular route than what the posted speed limit would allow, the server can probe to determine if there is construction, traffic incidences, sporting event related traffic, etc. and then augment the driving instructions based on this information.

In some embodiments of this application, the user may be provided with a web interface to define preferred locations, temporary locations, etc. and then have certain numbers of buttons on the user's mobile device defined or associated with such locations. Thus, the user can hit one button to receive directions to a business meeting stored in a temporary location, and then upon conclusion, press another button for directions to his or her office.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In this application the words “unit” and “module” are used interchangeably. Anything designated as a unit or module may be a stand-alone unit or a specialized module. A unit or a module may be modular or have modular aspects allowing it to be easily removed and replaced with another similar unit or module. Each unit or module may be any one of, or any combination of, software, hardware, and/or firmware.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1 A method for providing enhanced messaging services, the method comprising:
defining one or more trigger events;
receiving a message;
parsing the message for the presence of a trigger event;
in response to detecting a triggering event, invoking an action for the delivery of content to a destination.

2. The method of claim 1, wherein the received message is an SMS, and the SMS includes information to identify the content, wherein the step of invoking an action for the delivery of content further comprises the steps of:
identifying the sender of the SMS message;
verifying that the sender is approved to receive the identified content; and
sending the content to the sender.

3. The method of claim 2, wherein the step of sending the content to the sender further comprises sending the content in the form of an SMS.

4. The method of claim 1, wherein the received message includes content to be delivered and the trigger event identifies one or more destinations and the step of invoking an action further comprising the step of:
delivering the content to the one or more destinations.

5. The method of claim 1, further comprising the steps of:
receiving a content message including content to be delivered;
and the step of invoking an action for the delivery of content further comprises sending the content in the received content message to the destination.

6. The method of claim 5, wherein the received message is an SMS, and the SMS includes information to identify the content, wherein the step of invoking an action for the delivery of content further comprises the steps of:
identifying the sender of the SMS message;
verifying that the sender is approved to receive the identified content; and
sending the content to the sender.

7. The method of claim 1, wherein the received message is a voice message and the step of parsing the message further comprises detecting specific words within the voice message.

8. The method of claim 1, wherein the received message includes information to identify a product and a location, and the step of invoking an action for the delivery of content further comprises obtaining content related to the product and availability information related to the product and the location and further comprising the steps of:
identifying the sender of the message and
sending the obtained content to the identified sender.

9. The method of claim 1, wherein the received message includes information to identify the destination, and the step of invoking the action further comprises sending the content to the identified destination.

10. The method of claim 1, wherein the step of receiving a message includes receiving an SMS message and the step of invoking the action further comprising sending prerecorded content to a destination by out-dialing a number identified in the SMS message and playing the prerecorded content.

11. A system for providing an enhanced messaging service, the system comprising:
a content storage device; and
a media server that interfaces to the content storage device and a network, the media server including an application that is operable to:
receiving a message from the network;
parse the message for a trigger event;
upon detecting a trigger event, extract content from the content storage device; and
send the content to a destination over the network.

12. The system of claim 11, wherein the content storage device includes pre-recorded content and the media server is operable to parse the message for a trigger event by identifying particular pre-recorded content and a destination in the message, retrieving the pre-recorded content from the content storage device and delivering the pre-recorded content to the identified destination.

13. The system of claim 11, wherein the media server is further operative to obtain additional content by through the network and is further operable to include the additional content in the content sent to the destination.

14. The system of claim 11, wherein the content storage device further includes a plurality of trigger event definitions.

15. The system of claim 11, wherein the media server is further operable to:
receive a message containing trigger event definitions; and
store the trigger event definitions into the content storage device.

16. A method for providing enhanced messaging services, the method comprising the steps of:
receiving content for auto distribution;
receiving access rights definitions;
enabling auto distribution of content;
receiving a communication;
examining the communication for a trigger event;
if a trigger event is detected, automatically distributing the received content for auto distribution to authorized recipients, otherwise, apply normal processing to the received communication.

17. The method of claim 16, further comprising the steps of:
examining the received communication to identify the sender;
verifying the sender has access rights to the content by examining the received access rights definitions; and
if the sender does not have access rights, identifying the sender as an unauthorized recipient.

18. The method of claim 16, wherein the step of receiving content for auto distribution includes receiving content from a subscriber.

19. The method of claim 16, wherein the step of receiving content for auto distribution includes obtaining content over a network.

20. The method of claim 16, wherein in addition to automatically distributing the received content, applying normal processing to the received communication.
